(19) United States
(12) Patent Application Publication
(10) Pub. No.: US 2015/0000536 A1
(43) Pub. Date: Jan. 1, 2015

(54) Food Packaging Apparatus

(71) Applicant: Jennifer LANG, Wimberley, CA (US)

(72) Inventor: Jennifer LANG, Wimberley, CA (US)

(21) Appl. No.: 14/316,142

(22) Filed: Jun. 26, 2014

Related U.S. Application Data
(60) Provisional application No. 61/839,598, filed on Jun. 26, 2013.

(51) Int. Cl. A47G 19/12; A23L 1/22; A47J 27/04

(52) U.S. Cl. CPC A47G 19/12; A47J 27/04; A23L 1/22; A47J 2027/043; A23V 2002/00
USPC 99/359; 426/124; 426/113

(57) ABSTRACT

A food packaging apparatus includes a bowl, a lid, and a seasoning package, where the lid is selectively positioned with the bowl in between a closed configuration and an opened configuration. The closed configuration enables the food packaging apparatus to store frozen food and cook the stored frozen food through a steamer. The opened configuration allows the users to access the cooked food within the food package apparatus. The food packaging apparatus is made from biodegradable and compostable material in order to eliminate the plastic or paper wastage, minimize environmental impact of the production and disposal of the packaging apparatus, and the leaching of harmful chemicals during the steaming process.

The current application claims a priority to the U.S. Provisional Patent application Ser. No. 61/839,586 filed on Jun. 26, 2013.

### FIELD OF THE INVENTION

The present invention relates generally to frozen foods, compostable packaging, and steam cooking. More specifically, the present invention is a compostable packaging device for frozen foods. The packaging device allows for quick steaming of frozen foods and does not leach potentially harmful chemicals into the frozen foods during the steaming process.

### BACKGROUND OF THE INVENTION

The frozen food industry often flash freezes food during commercial processing. Flash freezing is a favored technique as flash frozen food retains as many nutrients as possible and ensures a relatively higher level of freshness and flavor. Food is generally frozen as soon as it is prepared or picked and then frozen in a specialized freezer for a period of time before being moved to a conventional freezer. The frozen food industry typically packages frozen food content in plastic or paper containers that are sealed with plastic film. The containers are generally heated, most often in a microwave or convection oven, prior to food consumption. While polyethylene terephthalate (PET) lined paper is sometimes used for food containers, the majority of these containers are composed of plastic and thrown away after the food is consumed. In addition to the harmful environmental impact of discarding plastic frozen food containers, heating food in these plastic or PET lined containers can release potentially harmful chemicals into the food. These chemicals are known to contribute to human disease such as by functioning as endocrine-disruptors and driving several types of hormone-driven cancers. In particular, freezing and reheating fatty foods such as meats, cheeses, and plant-derived oil cause chemicals to leach from the plastic containers. This problem is not isolated to the frozen food industry, however. For example, many disposable and reusable food/beverage containers contain traces of Bisphenol A (BPA), a known cancer-causing compound. BPA is commonly used in the manufacturing of polycarbonate plastics and epoxy resins. Polycarbonate plastics are often used in food/beverage storage containers while epoxy resins are used to coat metals such as the insides of food/beverage cans. Heating these food/beverage storage containers can potentially result in chemical release as well. The present invention seeks to address the aforementioned issues relating to the leaching of harmful chemicals when heating frozen food containers.

The object of the present invention is to provide an alternative to plastic frozen food containers that are prone to leaching harmful chemicals during the heating process. The packaging device of the present invention is composed of heat and moisture resistant, compostable, and biodegradable material as it meets following three criteria in order to be considered eco-friendly:
1) The material is biodegradable and is broken down by bacteria and other organisms into carbon dioxide, water, and biomass
2) The material disintegrates in compost and is indistinguishable from the surrounding compost
3) The material does not leave behind any ecologically toxic material residue but rather compost that can be used to support plant growth

### BRIEF DESCRIPTION OF THE DRAWINGS

FIG. 1 is a perspective view for the preferred embodiment of the present invention.

FIG. 2 is a side view of the preferred embodiment, showing the seasoning package being attached to the base of the bowl.

FIG. 3 is a side view of the preferred embodiment, showing the seasoning package being attached to the central portion of the lid.

FIG. 4 is a side view of the preferred embodiment with respect to the closed configuration, showing the plane upon which a cross sectional view is taken shown in FIG. 5.

FIG. 5 is a cross section view of the preferred embodiment taken along line A-A of FIG. 4.

FIG. 6 is a side view of the preferred embodiment with respect to the opened configuration, showing the plane upon which a cross sectional view is taken shown in FIG. 7.

FIG. 7 is a cross section view of the preferred embodiment taken along line A-A of FIG. 6.

FIG. 8 is a perspective view for the bowl of the preferred embodiment.

FIG. 9 is a side view for the bowl of the preferred embodiment.

FIG. 10 is a top perspective view for the lid of the preferred embodiment.

FIG. 11 is a bottom perspective view for the lid of the preferred embodiment.

FIG. 12 is a perspective view of the alternative embodiment of the present invention.

FIG. 13 is an exploded view of the alternative embodiment.

FIG. 14 is a side view of the preferred embodiment within the steamer.

### DETAIL DESCRIPTIONS OF THE INVENTION

All illustrations of the drawings are for the purpose of describing selected versions of the present invention and are not intended to limit the scope of the present invention.

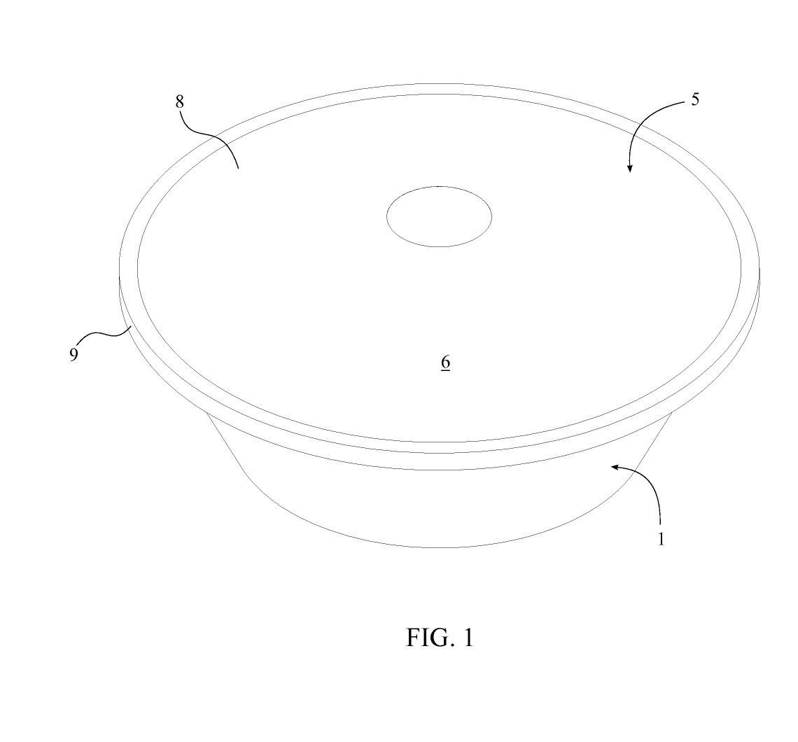

The present invention is a compostable packaging device for frozen foods as the present invention does not leach harmful chemicals into the frozen food during the heating process. The present invention is not limited to a specific material for the components of the packaging device; however all of the components of the present invention are made from biodegradable, heat resistant, and compostable material so that harmful chemicals can be eliminated from the present invention while providing an eco-friendly packaging device. The present invention is primarily intended for use during cooking by steaming as well as with natural, plant-based whole foods. In reference to FIG. 1, a preferred embodiment of the present invention comprises a bowl 1, a lid 5, and a seasoning package 12. The lid 5 is concentrically positioned with the bowl 1 as the lid 5 selectively positions in between a closed configuration 10 and an opened configuration 11. The closed configuration 10 allows the frozen food to be securely stored within the present invention while the opened configuration 11 allows the users of the present invention to access the stored frozen food.

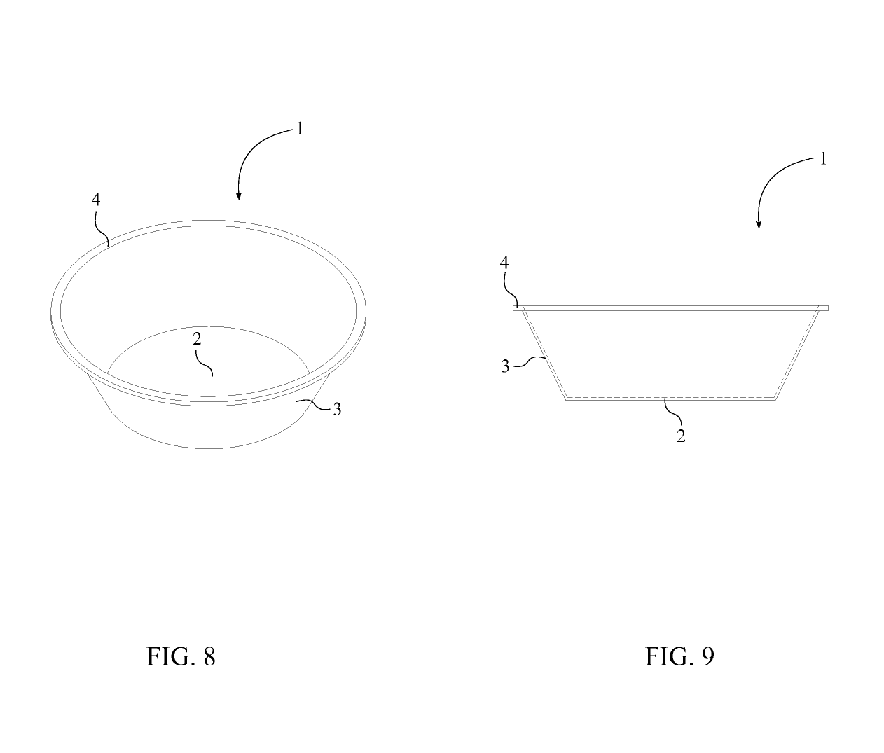

In reference to FIG. 8 and FIG. 9, the bowl 1 that functions as a storage container and a serving container within the present invention comprises a base 2, a lateral wall 3, and a brim 4. The lateral wall 3 is perimetrically connected around the base 2 from one end while the brim 4 is perimetrically connected around the opposite end of the lateral wall 3. More specifically, the brim 4 is oppositely positioned from the base 2 along the lateral wall 3 in such a way that the brim 4 and the base 2 are positioned parallel to each other. The brim 4 radially and outwardly extends from the lateral wall 3 so that the bowl 1 is able to securely attach with the lid 5. The bowl 1 is preferably shaped into a circular shape, but is not limited only to the circular shape and can be any other geometric or organic shapes within the present invention.

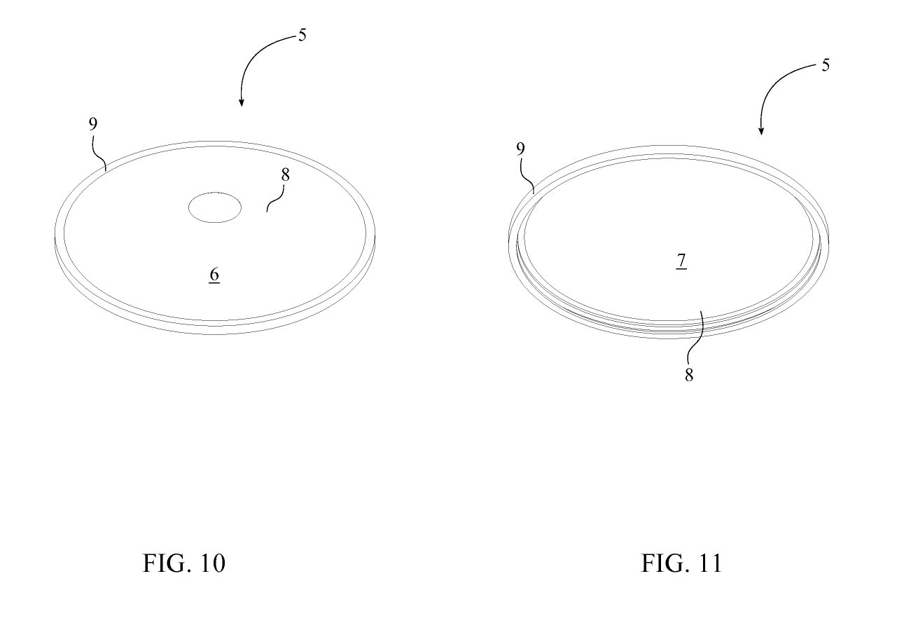

In reference to FIG. 10 and FIG. 11, the lid 5 that functions as a closing member and a drain plate within the present invention comprises an outer surface 6, an inner surface 7, a central portion 8, and an outer lip 9. The outer lip 9 is perimetrically connected around the central portion 8, and the outer surface 6 and the inner surface 7 are oppositely positioned of each other along the central portion 8 and the outer lip 9. Additionally, the central portion 8 can comprise a dome-shaped section and a flat section, where the dome-shaped section creates additional storage volume for the frozen food while the flat section provides stability for the present invention during the opened configuration 11. The outer lip 9 and the central portion 8 form the general shape of the lid 5, where the shape of the lid 5 directly related to the shape of the bowl 1 so that the lid 5 is able to attach with the bowl 1. For example, if the bowl 1 is shaped into a circular shape, the lid 5 is also shaped into a circular shape so that the bowl 1 and the lid 5 are able to efficiently function together within the closed configuration 10 and the opened configuration 11.

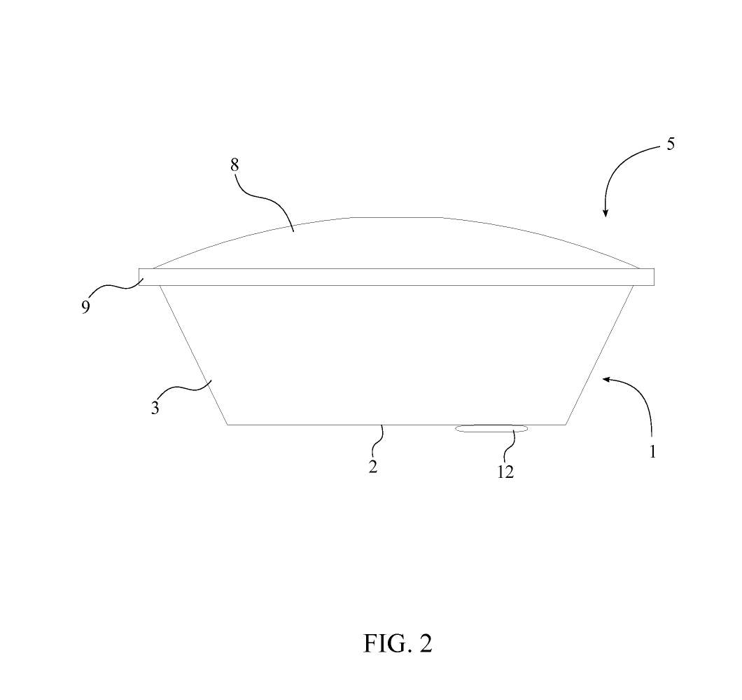

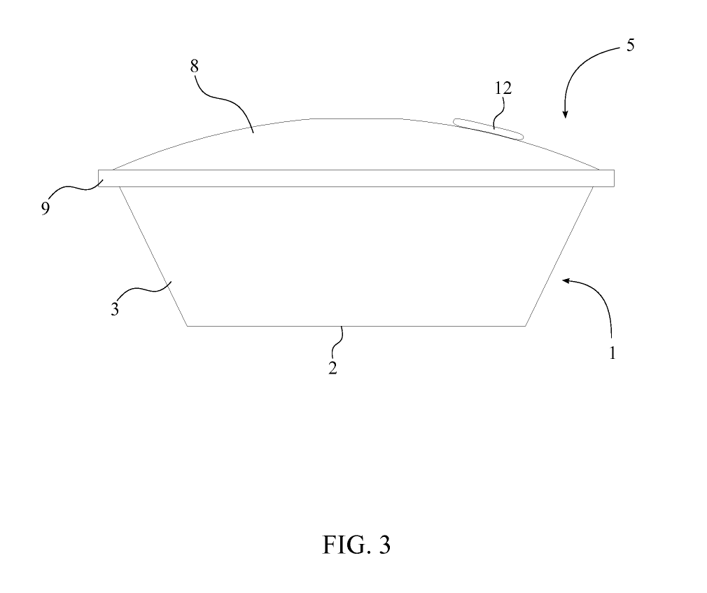

In reference to FIG. 2 and FIG. 3, the seasoning package 12 is attached onto the base 2 or central portion 8 so that the users of the present invention are able to remove the seasoning package 12 prior to the steaming process. The seasoning package 12 is filled with seasoning ingredients include, but are not limited to, spices, flavorings, and other seasonings that function as flavor enhancements for the frozen food.

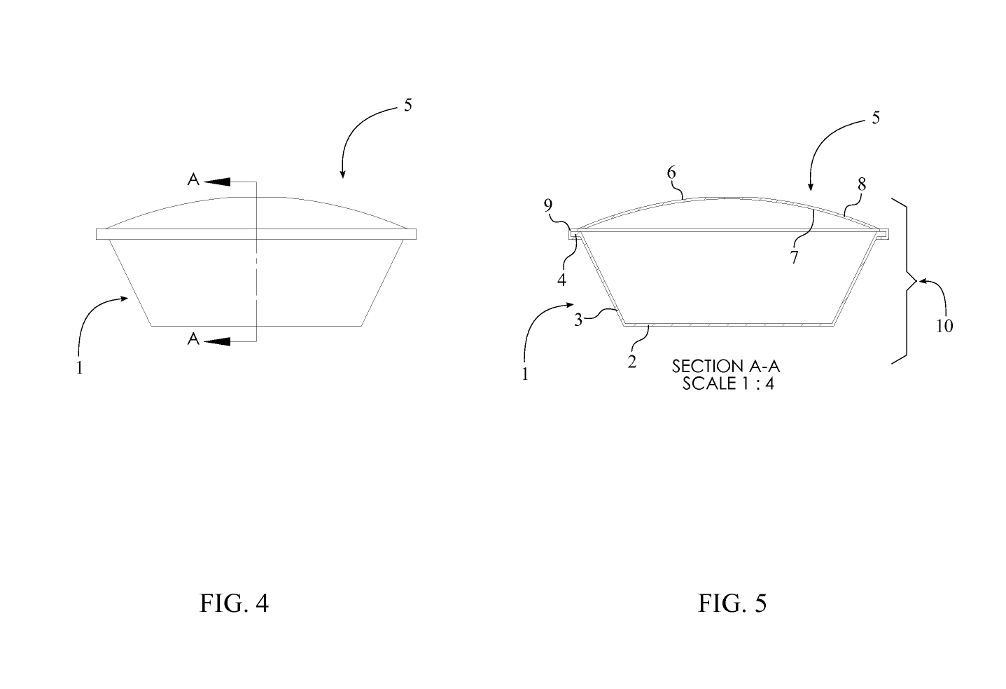

In reference to FIG. 4 and FIG. 5, the closed configuration 10 allows the frozen food to be stored within the present invention prior to the steaming process and during the steaming process, where the bowl 1 and the lid 5 function as the storage container and the closing member respectively. More specifically, the lid 5 is positioned atop the bowl 1 in such a way that the inner surface 7 is adjacently positioned with the brim 4. Then the outer lip 9 is perimetrically attached around the brim 4 completing the closed configuration 10 for the present invention. Since the bowl 1 and the lid 5 are attached together through the brim 4 and the outer lip 9, the present invention securely stores the frozen food within the bowl 1 and lid 5 during storage and efficiently steams the frozen food within the bowl 1 and lid 5 during the steam process.

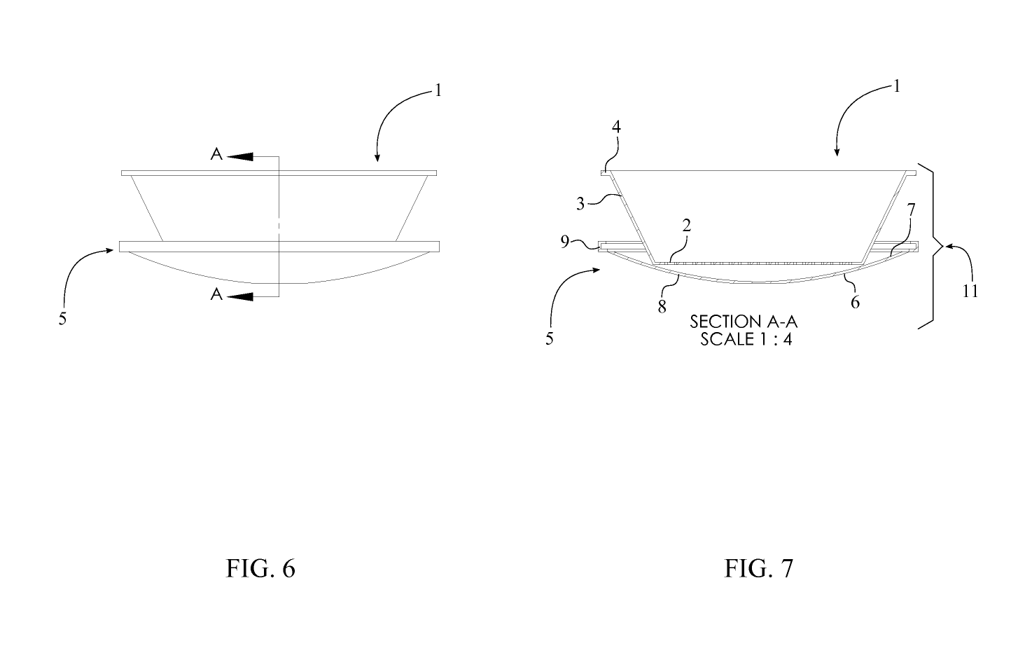

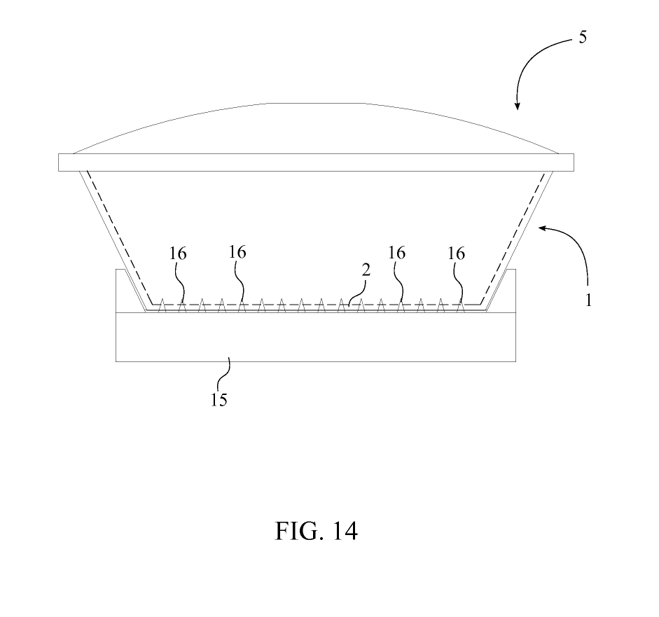

In order to steam the preferred embodiment of the present invention, the bowl 1 is positioned into a steamer 15 that comprises a plurality of punchers 16. In reference to FIG. 14, once the preferred embodiment is inserted into the steamer 15, the plurality of punchers 16 traverses through the base 2 and creates a plurality of openings within the base 2. The plurality of openings allows the steam generated from the steamer 15 to penetrate into the bowl 1 while the penetrated steam is contained by the lid 5. As a result, the steaming process is able to efficiently cook the frozen food within the preferred embodiment. Once the frozen food becomes cooked food through the steaming process, the users can consume the cooked food. In order to consume the cooked food, the users need to switch the present invention from the closed configuration 10 into the opened configuration 11, where the bowl 1 and the lid 5 function as the serving container and the drain plate respectively. In order words, users need to remove the lid 5 from bowl 1 and place the lid 5 directly beneath the bowl 1 to achieve the opened configuration 11 as seen in FIG. 6 and FIG. 7. More specifically, the bowl 1 is positioned atop the lid 5 in such a way that the inner surface 7 is adjacently positioned with the base 2 while the outer lip 9 is concentrically positioned around the lateral wall 3. Since the lid 5 is positioned below the bowl 1, the lid 5 functions as the drain plate within the opened configuration 11 of the present invention so that any kind of liquid that may drain after the steaming process can be trapped within central portion 8 of the lid 5. The user can also mix the seasoning ingredients of the seasoning package 12 with the cooked food upon their preference to enhance the flavor profile of the cooked food. During the opened configuration 11, the flat section is able to provide a stabilize surface for the preferred embodiment so that the bowl 1 and the lid 5 do not tilt or become unbalance. Alternately, the cooked food may be removed from the bowl 1, mixed with the seasoning ingredients, and served on a separate dish.

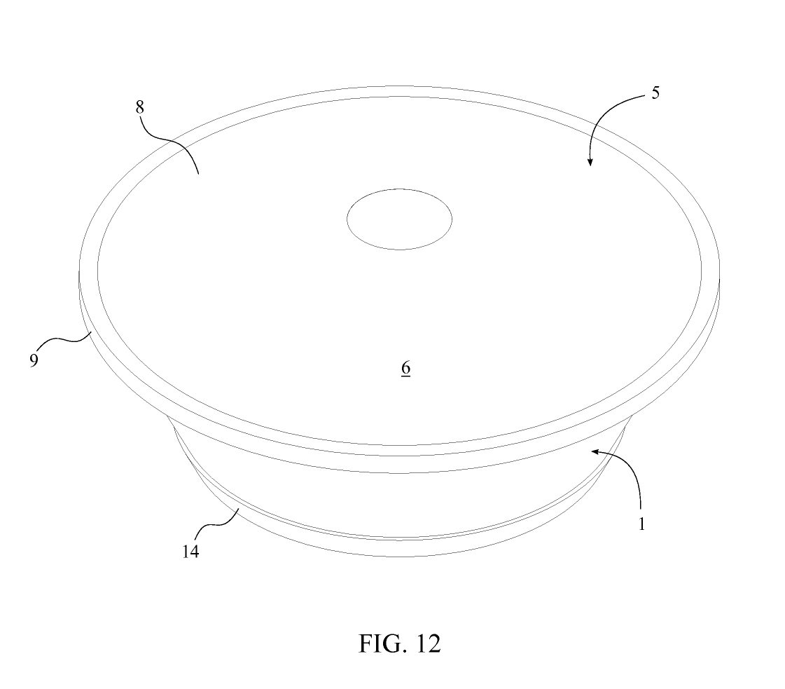

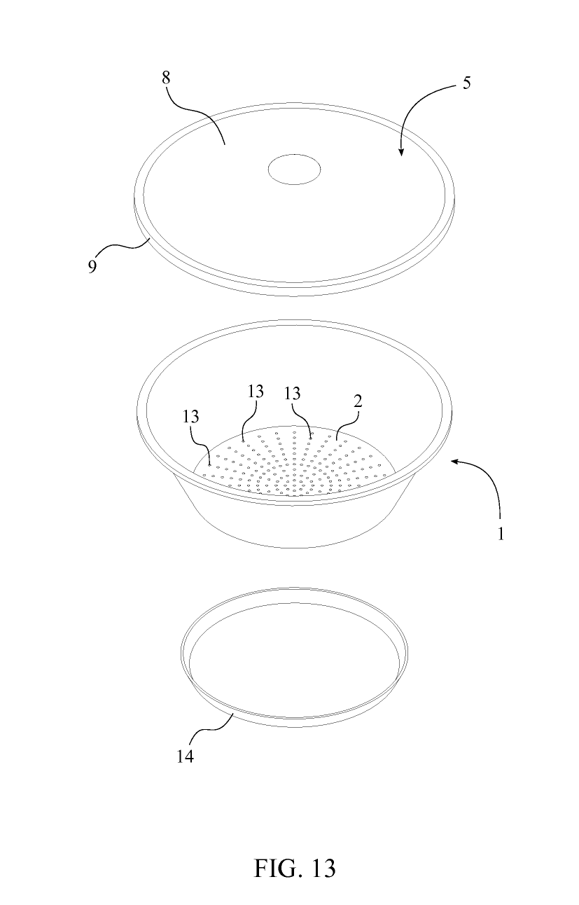

In reference to FIG. 12 and FIG. 13, an alternative embodiment of the present invention includes similar component as the preferred embodiment. However, the alternative embodiment further comprises a cover plate 14 and a plurality of holes 13. The plurality of holes 13 is traversed through the base 2, and the cover plate 14 is externally and concentrically attached with the base 2 opposite of the brim 4 so that the cover plate 14 is able to conceal the plurality of holes 13. The cover plate 14 functions as a protective barrier for the alternative embodiment so that the frozen food does not interact with outside elements prior to the steaming process. Before the alternative embodiment goes through the steaming process, the cover plate 14 has to be removed from the base 2. Then the bowl 1 is placed over a reservoir of boiling water that is ideally placed over a stove or other heat source. The boiling water vaporizes into steam that carries heat upwards through the plurality of holes 13, cooking the frozen food. Similar to the preferred embodiment, the user can consume the cooked food and mix the seasoning ingredients with the cooked food by switching the alternative embodiment from the closed configuration 10 to the opened configuration 11. Alternately, the cooked food may be removed from the bowl 1 of the alternative embodiment, mixed with the seasoning ingredients, and served on a separate dish.

A compostable plant fiber that can be yearly harvested and not tree-based is the preferred material is used as the preferred material for the present invention wherein the preferred material includes, but is not limited to, fibers such as those derived from sugarcane, cassava, wheat, bulgrass, and bamboo. Polylactic acid (PLA) is another one of the preferred material that the present invention can be made from. The PLA is derived from renewable resources such as corn starch, where the material is able to withstand high temperatures provided that temperatures do not approach the melting point of the thermoplastic. This makes the material ideal for applications such as that of the present invention as chemicals do not leach from the thermoplastic during heating. Heat resistant PLA is capable of withstanding temperatures up to 110° C. with a melting point of approximately 178° C. Additionally, PLA is food safe provided that any dyes and binders used are food safe as well. Since the present invention is primarily intended for use during cooking by steaming, the heat resistant PLA does not leach chemicals during steaming process provided that the temperatures do not approach the above mentioned melting point of the PLA. As such, PLA is one of an environmentally friendly choice of material for the present invention. The present invention can also be made from edible material so that the users are able to consume the bowl 1 and the lid 5 after the cooked food is consumed. Additionally, nutrients can be stored within the bowl 1 and the lid 5 to enhance the nutrition values of the frozen food. More specifically, the stored nutrients are retained within the present invention in such a way that the nutrients are able to mix into the frozen food during the steaming process.

Although the invention has been explained in relation to its preferred embodiment, it is to be understood that many other possible modifications and variations can be made without departing from the spirit and scope of the invention as hereinafter claimed.

What is claimed is:

1. A food packaging apparatus comprises:
a bowl;
a lid;
a seasoning package;
the bowl comprises a base, a lateral wall, and a brim;
the lid comprises an outer surface, an inner surface, a central portion, and an outer lip;
the lid being concentrically positioned with the bowl, wherein the lid selectively positions in between a closed configuration and an opened configuration; and
the bowl and the lid being biodegradable and compostable.

2. The food packaging apparatus as claimed in claim 1 comprises:
the lateral wall being perimetrically connected around the base;
the brim being perimetrically connected around the lateral wall;
the brim being oppositely positioned from the base along the lateral wall; and
the brim and the base being positioned parallel to each other.

3. The food packaging apparatus as claimed in claim 1 comprises:
the outer lip being perimetrically connected around the central portion; and
the outer surface being oppositely positioned from the inner surface along the central portion and the outer lip.

4. The food packaging apparatus as claimed in claim 1 comprises:
the closed configuration;
the lid being positioned atop the bowl;
the inner surface being adjacently positioned with the brim; and
the outer lip being perimetrically attached around the brim.

5. The food packaging apparatus as claimed in claim 4, wherein the seasoning package being attached onto the base.

6. The food packaging apparatus as claimed in claim 4, wherein the seasoning package being attached onto the central portion.

7. The food packaging apparatus as claimed in claim 4 comprises:
a steamer;
the bowl being positioned into the steamer; and
a plurality of punchers of the steamer traversing through the base.

8. The food packaging apparatus as claimed in claim 4 comprises:
a cover plate;
a plurality of holes;
the plurality of holes traversing through the base; and
the cover plate being externally and concentrically attached with the base opposite of the brim, wherein the cover plate conceals the plurality of holes.

9. The food packaging apparatus as claimed in claim 1 comprises:
the opened configuration;
the bowl being positioned atop the lid;
the inner surface being adjacently positioned with the base; and
the outer lip being concentrically positioned around the lateral wall.

10. A food packaging apparatus comprises:
a bowl;
a lid;
a seasoning package;
the bowl comprises a base, a lateral wall, and a brim;
the lateral wall being perimetrically connected around the base;
the brim being perimetrically connected around the lateral wall;
the brim being oppositely positioned from the base along the lateral wall;
the brim and the base being positioned parallel to each other;
the lid comprises an outer surface, an inner surface, a central portion, and an outer lip;
the outer lip being perimetrically connected around the central portion;
the outer surface being oppositely positioned from the inner surface along the central portion and the outer lip;
the lid being concentrically positioned with the bowl, wherein the lid selectively positions in between a closed configuration and an opened configuration; and
the bowl and the lid being biodegradable and compostable.

11. The food packaging apparatus as claimed in claim 10 comprises:
the closed configuration;
the lid being positioned atop the bowl;
the inner surface being adjacently positioned with the brim; and
the outer lip being perimetrically attached around the brim.

12. The food packaging apparatus as claimed in claim 10, wherein the seasoning package being attached onto the base.

13. The food packaging apparatus as claimed in claim 10, wherein the seasoning package being attached onto the central portion.

14. The food packaging apparatus as claimed in claim 10 comprises:
a steamer;
the bowl being positioned into the steamer; and
a plurality of punchers of the steamer traversing through the base.

15. The food packaging apparatus as claimed in claim 10 comprises:
a cover plate;
a plurality of holes;
the plurality of holes traversing through the base; and
the cover plate being externally and concentrically attached with the base opposite of the brim, wherein the cover plate conceals the plurality of holes.

16. The food packaging apparatus as claimed in claim 10 comprises:
the opened configuration;
the bowl being positioned atop the lid;
the inner surface being adjacently positioned with the base; and
the outer lip being concentrically positioned around the lateral wall.
